(19) United States
(12) Patent Application Publication
(10) Pub. No.: US 2002/0107922 A1
(43) Pub. Date: Aug. 8, 2002

(54) Processing apparatus, management apparatus, computer system, and memory medium and program

(76) Inventors: Toshihisa Nakamura, Kawasaki (JP); Hiroshi Oki, Kawasaki (JP); Akio Munakata, Machida (JP)

Correspondence Address: STAAS & HALSEY LLP, 700 11TH STREET, NW, SUITE 500, WASHINGTON, DC, 20001, US

(21) Appl. No.: 10/066,585

(22) Filed: Feb. 6, 2002

(30) Foreign Application Priority Data
Feb. 8, 2001 (JP) 2001-032438

(51) Int. Cl. G06F 15/16

(52) U.S. Cl. 709/205; 709/208

(57) ABSTRACT

A method and system for remotely operating one or more client apparatuses by a controlling client apparatus without placing a processing burden on the apparatuses or increasing network traffic. Processing is executed in response to a request from a first apparatus. The processing results are transmitted to both the first apparatus and to a second apparatus. In one embodiment of the present invention, the first apparatus sends a request to a management apparatus to remotely control the second apparatus. The management apparatus disables user operation of the second apparatus and establishes remote operations between the first and second apparatuses. The first apparatus requests a Web page from the management apparatus, which obtains the Web page from a WWW server and sends the Web page to both the first and second apparatuses. Thus, remote control of the second apparatus is achieved by the first apparatus.

### BACKGROUND OF THE INVENTION

1. Field of the Invention

The present invention is directed to remote operational control of apparatuses and equipment.

2. Description of the Related Art

In recent years, it has become quite common, using computers (most typically, personal computers and set top boxes) to access WWW servers (also known as Web sites) that are connected to the Internet. Accessing these WWW servers using Web browsers, users can peruse the Web pages provided by the WWW servers and obtain various kinds of information. Accessing Web pages using the Internet has become quite popular, and accompanying this phenomenon, the number of computer users has increased and extended to all ages.

In addition, it has become possible to build systems that use networks without incurring large expenses. Consequently, the number of firms involved in the following businesses has become quite large: (1) building intra-company systems that use the Internet, and (2) providing various kinds of services using the Internet, such as correspondence education services, in-home nursing care services, etc. Thus, people who have not previously used computers (e.g., company employees and even children and elderly people) are now in situations where use of computers is inevitable. As a consequence, technology is needed that enables these “computer beginners” to more easily view desired Web pages.

In general, Web pages use Uniform Resource Locators (URLs) to indicate the “address” of the page. Normally, a URL is expressed as a string of letters comprising the communication protocol name, the server name, the directory name, and the file name. By specifying a URL with the Web browser, the user can view the desired Web page. However, the number of letters in the URL may be large and it may become very difficult for children, elderly people, and other computer beginners to memorize the URL. As a result, users often do not accurately input the URL using the Web browser and, thus, cannot access the desired Web page.

Furthermore, instead of directly inputting the URL that indicates the desired Web page, it is possible to designate the URL of the Web site (home page) where the Web page is located and, by selecting links within the displayed Web home page, reach and view the desired Web page. However, with this method, to reach the desired Web page from the home page, it is necessary to know where in the content of the home page links to other pages have been created. In addition, the user must know which link to follow to reach the desired Web page. Consequently, even with this method, there is a high possibility that computer beginners will not be able to view the desired Web page.

In cases, as described above, involving users who are not familiar with computer operation, the problem can be solved by having another user operate the computer remotely. Techniques related to remote operation have been disclosed in the Japanese official bulletin “Patent Application Opened for Public Comment” number H10-301874.

In this official bulletin, technology is disclosed that has the objective of providing a computer system that can remotely operate a computer, even if the remote computer contains no software for enabling remote operation. The technology uses the graphical user interface (GUI) screen of the remote apparatus and handles its operation using a Web browser. While it is possible to operate a remote apparatus using the technology disclosed in the official bulletin, this technology has the following problems.

With the technology disclosed in the official bulletin, the controlling or master apparatus must access the apparatus to be remotely operated (slave apparatus) via a network and send the remote apparatus a program that enables remote operation. As a result, when a number of apparatuses are to be remotely operated at different locations, each apparatus must be accessed, receive the program enabling remote operation, and send the controlling apparatus the “right to operate.” Even if the details of remote operation are the same for each apparatus, it is still necessary to access each apparatus. The tasks of accessing an apparatus to be remotely operated, performing remote operation, and releasing the apparatus from remote operation must be repeated for each apparatus. Thus, this method requires time and effort from the user and puts a burden of work on the user.

Also, in the official bulletin, the details of the operations performed by the controlling apparatus must be communicated to the apparatuses that are remotely operated. Then, a command must be sent to display on the controlling apparatus the results of the program executions at the remote apparatuses. This results in a large increase in network traffic. In addition, although the network load could be reduced through compression of the messages, the processing load on each apparatus resulting from compression processing would become quite large.

As an alternative method not addressed by the official bulletin above, all the apparatuses to be remotely operated could be simultaneously accessed, remotely operated, and released from remote operation. However, the programs received by the apparatuses must be executed in parallel with a number of Web browsers running, so the processing load becomes high. In addition, because it is necessary to display the operating status of each remote apparatus on a display of the controlling apparatus, the display area for the controlling apparatus becomes limited, making it difficult to grasp the operating status of a remotely-operated apparatus.

### SUMMARY OF THE INVENTION

An objective of the present invention is to provide a technique for achieving remote operation through simple user operations. Another object of the present invention is to provide a technique for achieving remote operation without adding a processing load on the various apparatuses, and to minimize growth in network traffic.

The above objects are attained by providing a system, apparatus, and method of receiving, a request from a first control unit/apparatus, processing the request, and simultaneously transmitting the processing results to the first control unit/apparatus and to a second control unit/apparatus that is different from the first control unit/apparatus.

In one embodiment of the present invention, the first apparatus sends a request to a management apparatus to remotely control the second apparatus. The management apparatus obtains connection permission from the second apparatus. If the second apparatus gives connection permission, remote operations are established between the first apparatus as a master client and the second apparatus as a slave client, and user operations of the second apparatus are disabled. The first apparatus requests a Web page from the management apparatus. The management apparatus obtains the Web page from a WWW server and sends the Web page to both the first and second apparatuses. Thus, remote control of the second apparatus is achieved by the first apparatus.

Also, the slave client may initiate a connection request, and either the slave client or the master client may request disconnection from the remote operation relationship between the master and slave clients.

These objects, together with other objects and advantages that will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a simplified block diagram according to the present invention, illustrating the arrangement of clients and servers with respect to a network.

FIG. 2 is a block diagram of a client or server computer hardware configuration, according to the present invention.

FIG. 3 is a flow diagram of registration processing for implementing remote operation, according to the present invention.

FIGS. 4 and 5 are flow diagrams of client connection processing according to the present invention.

FIG. 6 is a flow diagram of client disconnection processing performed by a proxy server of the present invention.

FIG. 7 is a flow diagram of Web page viewing processing performed by the proxy server of the present invention.

FIG. 8 is a flow diagram of the processing of a master client of the present invention.

FIG. 9 is a flow diagram of the processing of a slave client of the present invention.

FIG. 10 is a portion of a user database of the present invention.

FIGS. 11-13 are block diagrams of the main information exchanged between a client and the proxy server of the present invention.

FIGS. 14 and 15 are example screen layouts of a client of the present invention.

### DESCRIPTION OF THE PREFERRED EMBODIMENTS

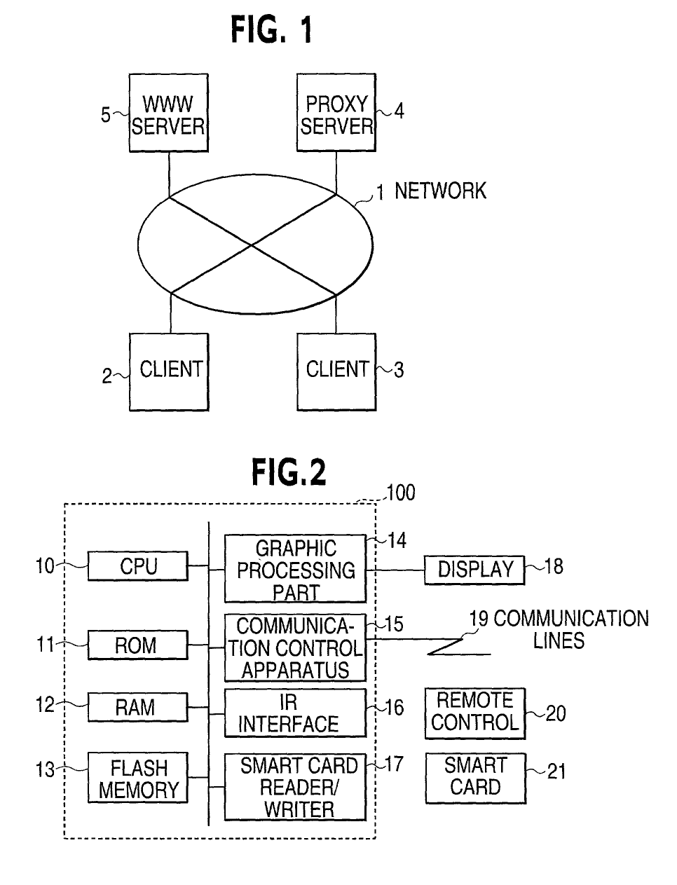

FIG. 1 shows a sample network configuration for implementation of the present invention. FIG. 1 comprises a network 1, clients 2 and 3, a proxy server 4, and a WWW server 5. More clients and WWW servers may be included in the system than those shown in FIG. 1.

In FIG. 1, the network 1 may be a telephone circuit network, a Local Area Network (LAN), the Internet, which is a wide area network, etc. The clients 2 and 3 are conventional computers, such as personal computers, workstations, set top boxes, etc. Clients 2 and 3 of FIG. 1 are apparatuses that may function as either a controlling apparatus that operates other apparatuses (hereinafter referred to as a “master client”) or as an apparatus that may be remotely operated (hereinafter referred to as a “slave client”). Moreover, each client may be set up ahead of time to perform either function. Likewise, the proxy server 4 and WWW server 5 are conventional computers having public knowledge configurations, such as workstations, personal computers, etc.

The proxy server 4 performs processing based on master client operations, and sends the results of the processing back to the master client and, at the same time, to the slave client. The proxy server 4 facilitates remote operation according to the present invention. The WWW server 5 may be, for example, a WWW server provided by an Internet Service Provider (ISP), an Application Service Provider (ASP), or a WWW server that uses one of these service providers to provide various services and information to clients.

In the embodiment shown in FIG. 1, the WWW server 5 provides Web pages that are perused by the master client. If remote operations are being performed, the WWW server 5 is accessed via the proxy server 4. Otherwise, it is not necessary to access the proxy server 4. For remote operations, the proxy server 4 sends the requested Web pages to the master client and, at the same time, sends the Web page with the same content to the slave client to achieve remote operation of the slave client by the master client.

An example of the hardware configuration of the clients and servers is illustrated in FIG. 2. FIG. 2 illustrates a hardware configuration of a computer 100 that is a set top box functioning as an Internet apparatus. The computer 100 comprises a CPU 10, a ROM 11, a RAM 12, a flash memory 13, a graphic processor 14, a communication control apparatus 15 (for accessing networks), an infrared (IR) interface 16, and a smart card reader/writer 17. In addition, a display 18 is connected to the graphic processor 14 and communication lines 19 are connected to the communication control apparatus 15. Positioned at the IR interface 16 is a remote controller 20, which communicates with the interface infrared signals. A smart card 21 is written to, or read from, using the smart card reader/writer 17.

The clients 2 and 3 and the proxy server 4 do not need all the configuration elements shown in FIG. 2 and may be equipped with the minimum configuration elements required to implement the present invention. Also, any configuration element that accomplishes the same function is acceptable, regardless of its class, and it is also acceptable for a configuration element to jointly perform a function with another element.

The CPU 10 executes various programs and controls the entire computer 100. The ROM 11 is a non-volatile memory that stores the programs for starting or shutting down the computer 100 and the programs that control the basic operation of the computer 100, such as programs for controlling hardware based on the processing content of host (high order) applications. In addition, the ROM II stores machine identification (MID) information that uniquely identifies the computer 100.

The RAM 12 is a volatile memory used to hold the processing results of the program that controls the computer 100 as that program executes, as well as temporary data for processing. The RAM 12 also holds data that are developed for display on the screen of the display 18. The display data that are developed in the RAM 12 are sent via the graphic processor 14 and displayed on the display 18. In a set top box of the type used in the embodiment of FIG. 2, a television broadcast receiver is generally used as the display unit.

The flash memory 13 is a non-volatile memory that stores program and control data. The Web browser program, which will be described later, is stored in the flash memory 13 and, in response to a “read out” instruction from the CPU 10, is read from the flash memory 13 and executed in the RAM 12.

The communication control apparatus 15 exchanges data with other apparatuses via the communication lines 19 and also downloads programs. The communications control apparatus 15 should be compatible with the type of communication line used for data communication. For example, if telephone circuits are used, a modem would be appropriate, but where a high speed data communication network such as the Internet is used, a LAN interface is preferred.

The IR interface 16 is the optical receptor for infrared communication. The IR interface 16 receives IR signals indicating the operational commands that have been transmitted from the remote controller 20. The remote controller 20 (also referred to as the “controlling apparatus”) is equipped with number keys, movement keys (for example, UP, DOWN, LEFT, RIGHT, etc.) for moving the focus that is displayed on the screen, and a decision button for selecting a display item that currently has the focus. The remote controller 20 outputs operational commands as IR signals in response to user manipulation of these keys and buttons.

The smart card reader/writer 17 reads information recorded on the smart card 21 (also referred to as an “IC card”), updates information recorded on the smart card 21, and records new information on the smart card 21. In addition, information is recorded on each smart card 21, such as individual identification information (ID), for specifying each user, information necessary for using each service, etc.

In FIG. 2, the CPU 10 executes processing according to various programs based on the IR signals that indicate the operations performed on the remote controller 20. In response to the processing, information is displayed on the display 18 and data are transmitted via the communication lines 19.

In the embodiment of FIG. 2, the flash memory 13 is used as the non-volatile memory, but a configuration using a hard disk drive or other recording device would also be acceptable. Also, an IR interface is used for receiving commands, but a keyboard, mouse, etc. may be used instead. In addition, the method of data communication with the computer 100, including using the remote controller 20, may be performed either by a wired or wireless scheme. Also, a set top box is used as an example of the computer 100. However, other devices may be used as the client and the proxy servers that are adequate to implement the present invention, such as conventional personal computers, devices that use networks, etc.

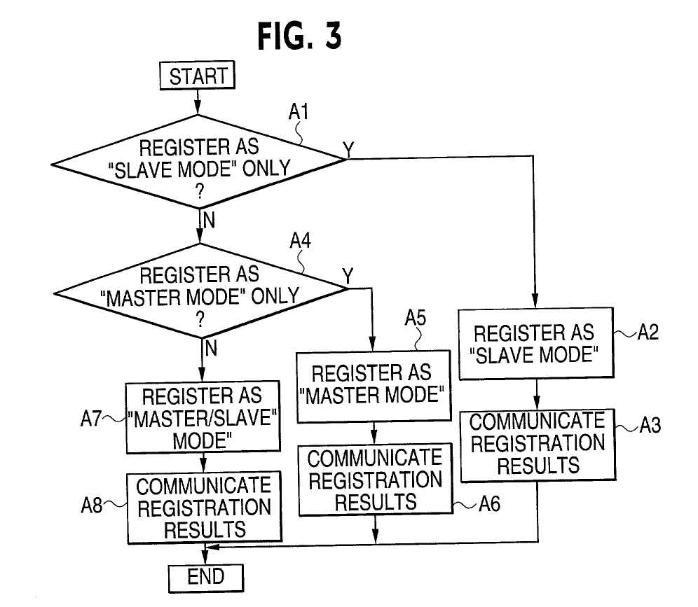

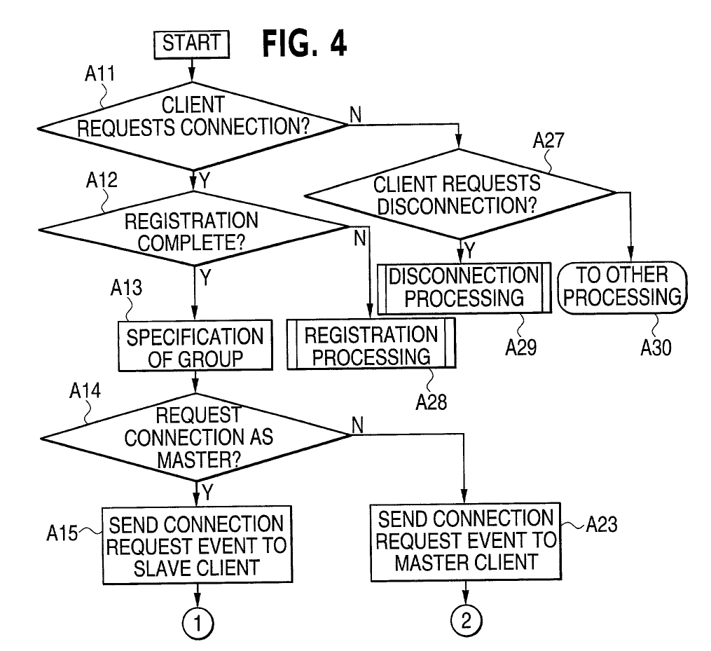

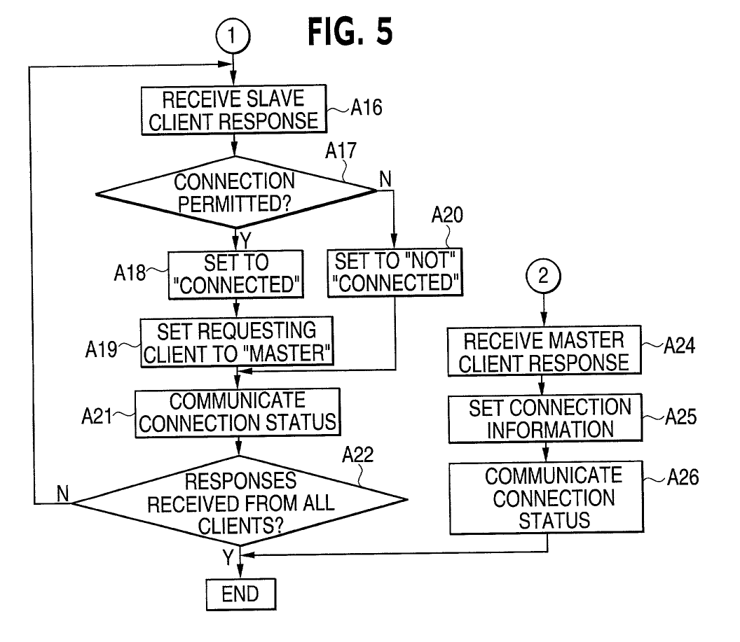

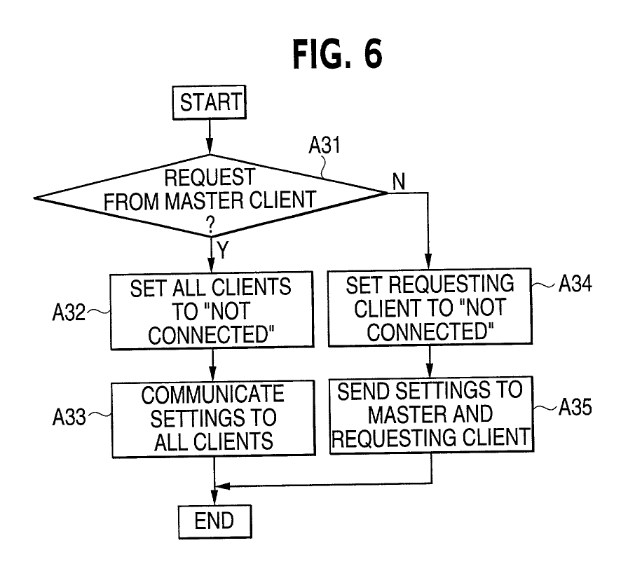

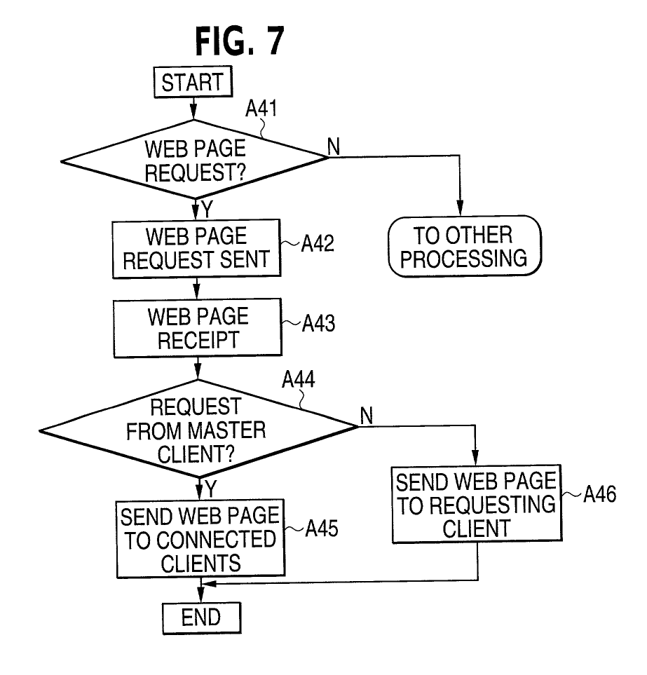

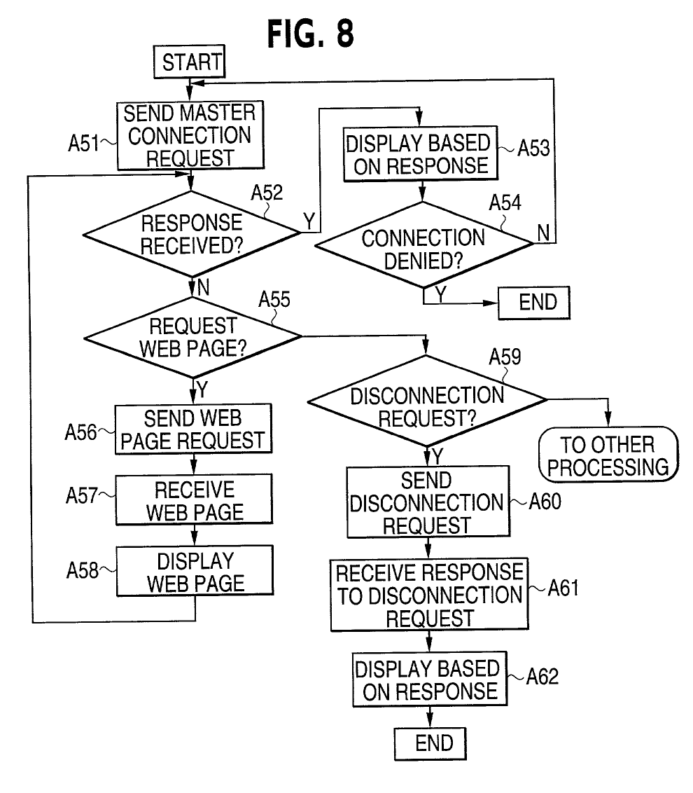

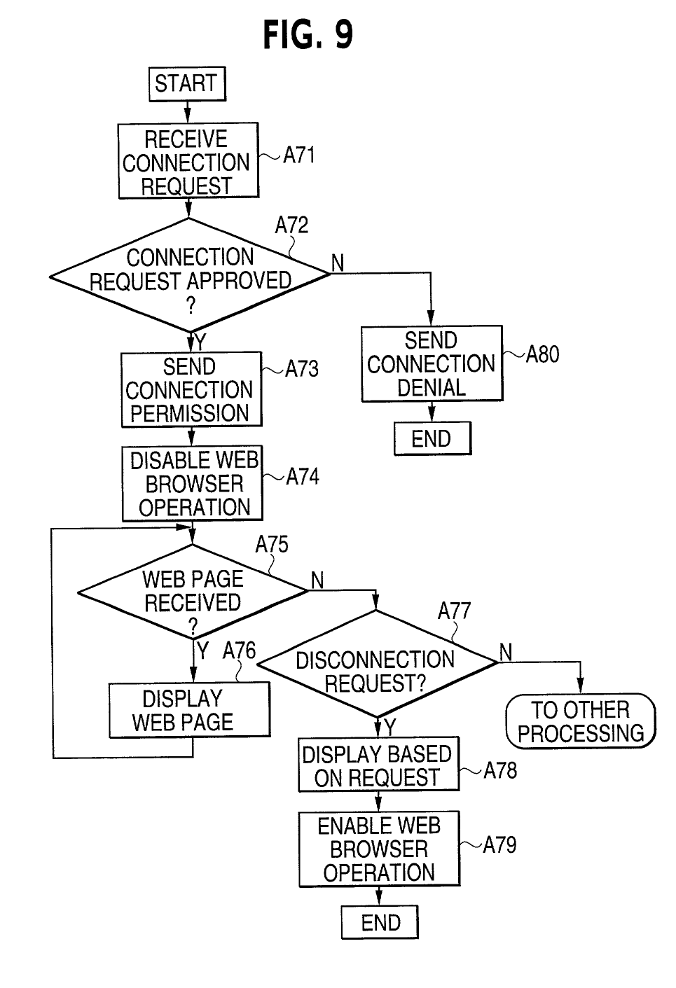

For illustration purposes in FIGS. 1 and 2, client 2 functions as the master client and client 3 functions as the slave client. Through the proxy server 4, the master client 2 remotely operates the slave client 3. The flow diagrams of FIGS. 3-9 describe processing according to programs executed on client 2, client 3, and the proxy server 4. FIG. 3 is a flow diagram of registration processing. FIG. 4 and FIG. 5 are flow diagrams of client connection processing, while FIG. 6 is a flowchart for disconnecting a client that is in a connected state. FIG. 7 is a flow diagram of Web page viewing processing. FIG. 8 is a flow diagram of the master client 2 processing, while FIG. 9 is a flow diagram of the slave client 3 processing. The proxy server 4 performs the processing shown in FIGS. 4 through 7.

The registration processing shown in FIG. 3 may be performed by an operator before the computer 100 is delivered to the user. Alternatively, after delivery to the user, registration processing may be executed by the proxy server 4 when accessed by either client 2 or client 3. In describing the registration processing of FIG. 3, registration processing is performed by the proxy server 4 in response to access from either client 2 or client 3.

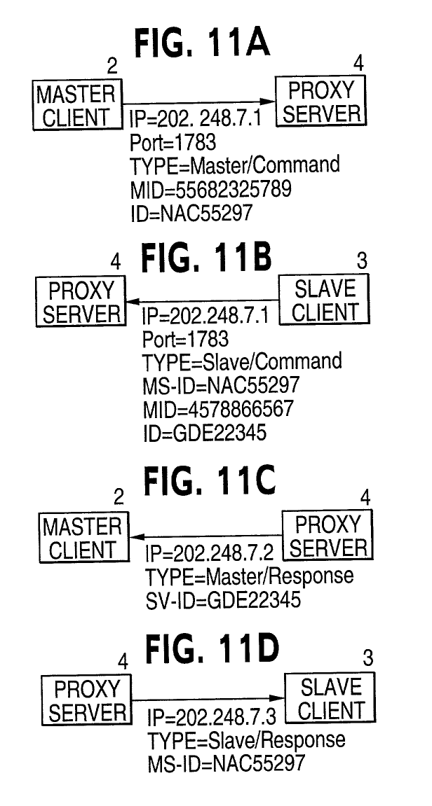

In addition, FIGS. 11 through 13 illustrate the main information that is sent and received between client 2, client 3, the proxy server 4, and the WWW server 5 according to the processing illustrated in FIGS. 3 through 9.

In the registration processing shown in FIG. 3, the user accesses the proxy server 4 through either client 2 or client 3, and specifies “mode registration” to set the user's apparatus to either slave mode, master mode, or master/slave mode. Here, “slave mode” is the mode wherein the client is set to be a slave client, “master mode” is the mode wherein the client is set to be a master client, and “master/slave mode” is the mode wherein the client is set to be either a master client or a slave client. The user also specifies the URL of the proxy server 4. The URL of the proxy server 4 may be stored in advance in clients 2 and 3, or the URL may be recorded in the smart card 21. In either configuration, the URL is read out and used when needed.

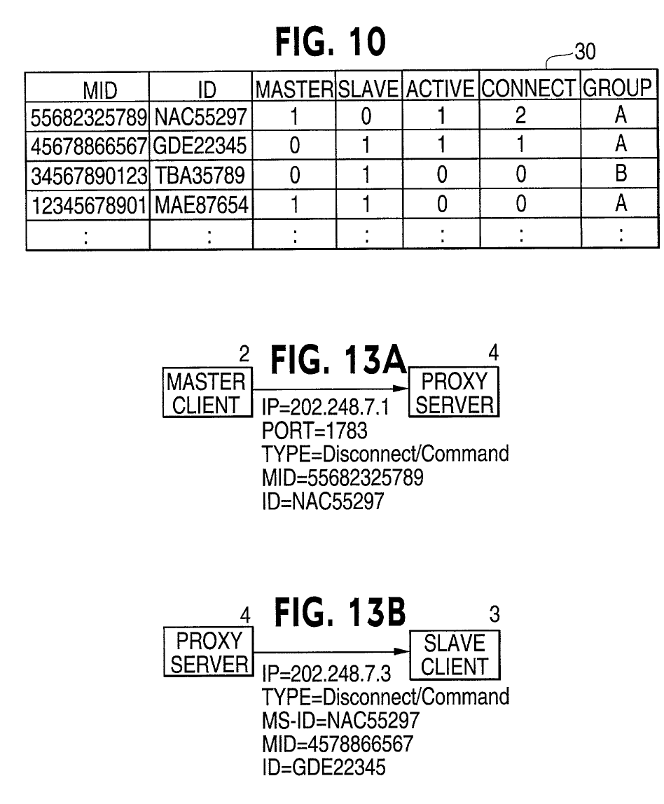

In this example, the client 3 user accesses the proxy server 4 selecting the “slave mode” setting from a menu (not shown), and the client 2 user accesses the proxy server 4 selecting the “master mode” setting from a menu (not shown). The proxy server 4 receives from client 2 or client 3 an access request with the specified mode registration and registers the data in a user database 30 shown in FIG. 10. The proxy server 4 returns information to the requesting client for setting the specified mode.

For example, at A1-A3 of FIG. 3, when the proxy server 4 receives from client 3 a mode registration access request specifying “slave mode,” it sets to “active” only the slave mode field (Slave) for client 3 in the user database 30 and posts information that client 3 has been set to the slave mode.

Likewise, at A4-A6 of FIG. 3, when the proxy server 4 receives from client 2 a mode registration access request specifying “master mode,” it sets to “active” only the master mode field (Master) for client 2 in the user database 30 and posts information that client 2 has been set to the master mode.

In addition, at A7 and A8 of FIG. 3, when a mode registration access request is received from a client specifying the “master/slave mode,” the proxy server 4 sets to “active” both the slave mode and master mode fields for that client in the user database 30, and posts the setting results for that client.

Thus, registration processing determines and sets the client modes of operation.

FIG. 4 and FIG. 5 are flow diagrams of client connection processing. During client connection processing, a client accesses the proxy server 4, which determines at A11 whether the access request is a connection request. If the proxy server 4 determines that the access request is a connection request from a client, the proxy server 4 determines at A12 whether the client sending the request is registered either in the slave mode or the master mode. To determine the mode registration status, the user database 30 is accessed. If the client that generated the connection request has either the master mode (Master) or the slave mode (Slave) set to “active,” that client is determined to be registered.

As shown in FIG. 10, the user database 30 is comprised of the following fields: machine identification information (MID), individual identification information (ID), master mode (Master), slave mode (Slave), network connection status (Active), client connection status (Connect), and registration group (Group). In this database, each client is represented by one record, and the data for all fields related to that client are included in the record.

The machine identification information (MID) is used to identify clients by providing a unique machine ID for each client. The individual identification information (ID) identifies users and is used to authenticate service usage and to calculate fees for service usage. The master mode (Master) indicates whether a client may become a master client. If a “1” is set for this field, the client can become a master client. If a “0” is set, the client cannot become a master client. The slave mode (Slave) indicates whether a client may become a slave client. If a “1” is set for this field, the client can become a slave client. If a “0” is set, the client cannot become a slave client. If a “1” has been set in both the master mode (Master) field and the slave mode (Slave) field, then that client can become either a master client or a slave client.

The network connection status (Active) indicates whether a client is connected to a network. If a “1” is set for this field, the client is currently connected to the network, while a “0” indicates the client is currently not connected to the network. The client connection status (Connect) indicates whether a client's status is “remote operation”. For example, if a “1” is set for this field, the client is currently a slave client. If a “2” is set for this field, the client is currently a master client. If a “0” is set for this field, the client is not in remote operation mode. Alternatively, if a client may only become either a master client or a slave client, the following entries may be used for the client connection status (Connect) field to show which of the two possible states is in effect: “in remote operation status” (for example, a “1” as the field entry) or “not in remote operation status” (for example, a “0” as the field entry).

The group affiliation (Group) indicates the group to which the client belongs. The group may be indicated by, for example, a group name. By referring to the affiliated group, the group to which the client belongs may be identified.

If set top boxes are distributed to clients that are service contract users, certain information is registered in the user database 30 at the time the set top boxes are allocated. This information includes the machine identification information (MID), the individual identification information (ID), and the affiliated group (Group). In addition, the master mode (Master) and slave mode (Slave) fields may be registered in the user database 30 when the set top boxes are allocated, as described above by referring to FIG. 3. The registration modes are entered into the user database 30.

The content of the fields set in the user database 30 may be changed according to the applicable service structure. For example, the user database 30 fields of machine identification information (MID) and individual identification (ID) are both used in FIG. 10, but either one may be used alone. Also, as long as it is possible to specify the client, information other than MID and ID may be registered in the user database 30.

Returning to the description of connection processing as shown in FIG. 4, whether client registration is complete is determined at A12 by whether either the master mode (Master) field or slave mode (Slave) field has been set to “active” in the user database 30 of FIG. 10. In other words, if a “1” is set for either field, it is determined that the client is registered, but if a “0” is set for both fields, it is determined that the registration processing has not been completed for the client. If registration processing is not complete, the proxy server 4 executes at A28 the registration processing shown in FIG. 3 and completes the mode registration of the client.

If mode registration has been completed for the client, the group to which the client belongs is specified at A13 using the user database 30 of FIG. 10. In specifying the group affiliation, the content of the “affiliated group” (Group) field may be referred to for the client requesting connection.

After specifying the affiliated group of the client requesting connection, it is determined at A14 whether the request is for establishing the master mode or the slave mode of operation. The mode that the client is requesting is contained in the connection request. If the client requests connection in the master mode, a “connection request event” is sent at A15 to each client, belonging to the same group as the requesting client, that can become a slave client. Clients that are currently connected to the network and that can become slave clients will have the same affiliated group (Group) as the “connection requesting” client specified by the processing at A13, a “1” as the value in the slave mode (Slave) field, and a “1” as the value for network connection status (Active).

Referring to FIG. 5, after sending a connection request event at A15 to all other clients, responses to the connection request event are received at A16. Based upon the responses, the proxy server 4 decides at A17 whether connection should be permitted.

If a response indicates at A17 that connection should be permitted, a “1” is set at A18 in the client connection status (Connect) field of the user database 30 corresponding to the responding client indicating slave mode. In the user database 30 corresponding to the client that made the connection request, a “2” is set in the client connection status (Connect) field at A19 indicating master mode. On the other hand, if the response indicates at A17 that connection should not be permitted, a “0” is set at A20 in the client connection status (Connect) field of the user database 30 corresponding to the responding client, indicating that the responding client is not connected.

After making the settings described above in the user database 30 according to the responses from the clients, the settings are transmitted at A21 to the client requesting connection and to the clients that responded to the connection request event. If none of the clients that could become slave clients is able to connect, the client that made the request for connection is notified to that effect. The steps above are repeated at A22 until responses are received from all the clients receiving connection request events. After processing the responses, connection processing is completed, thereby establishing remote operation with the client requesting connection as the master client and the other clients as the slave clients.

If the client requests connection in the slave mode at A14 of FIG. 4, a connection request event is sent at A23 to the clients belonging to the same group as the requesting client that could become master clients. Clients that are currently connected to the network and that can become master clients will have the same affiliated group (Group) as the client requesting connection, a “1” as the value in the master mode (Master) field, and a “1” as the value for network connection status (Active).

After sending a connection request event at A23 of FIG. 4 to all other clients, responses to that connection request event are received at A24 of FIG. 5. Based on the responses, the proxy server 4 sets connection information at A25 in the user database 30. If a response indicates that connection should be permitted, a “2” is set in the client connection status (Connect) field of the user database 30 corresponding to the responding client, indicating master mode. In the user database 30 corresponding to the client that made the connection request, a “1” is set in the client connection status (Connect) field, indicating slave mode.

The settings described above are then transmitted at A26 to the client requesting connection and to the clients that responded to the connection request event, establishing remote operation with the client requesting connection as the slave client and the other clients as the master clients.

Although some of the processing details at A24-A26 of FIG. 5 have been omitted, these details are the same as those at A16-A21 of FIG. 5, with slave and master clients being interchanged.

If the request at A11 of FIG. 4 is not a connection request, it is determined at A27 whether the request is a disconnection request. Where a remote operation relationship has been established between a master client and a slave client, either client may request release from the relationship. When the disconnection request is received, disconnection processing is executed at A29, as shown in FIG. 6. However, if the request is not for connection or disconnection, processing is executed at A30 in response to the type of request. For example, if the request is related to Web page viewing, then the processing shown in FIG. 7 is executed, which is described below.

FIG. 6 is a flow diagram of disconnection processing that is executed by the proxy server 4 when a disconnection request is received from a client. Upon receipt of a disconnection request from a client, the proxy server 4 determines at A31 whether the request is from a master client or a slave client. In determining whether the client that has made the request is a master client or a slave client, the machine ID information for that client, which is contained in the request, is used to find information about that client in the user database 30. The decision is based on the content of the client connection status (Connect) field for that client. In other words, at A31, if the client connection status (Connect) is set to a “1”, it is determined that the client that has made the disconnection request is a slave client. If the client connection status (Connect) is set to a “2,” it is determined that the client that made the disconnection request is a master client.

If it is determined that the disconnection request is from a master client, the following changes are made to the affiliated group (Group) fields of the user database 30 that are the same as that of the master client. The client connection status (Connect) field is set to “0” for all the clients that have a “1” for network connection status (Active) and a “1” or “2” for the client connection status (Connect) field.

Thus, the master client and the slave clients under remote operation with respect to the master client (i.e., connected status) are given a disconnected status at A32. After making the settings changes to the user database 30, the disconnection processing is completed by sending notification at A33 that the connection between the master client and the slave clients has been terminated by communicating the new settings to all the clients.

On the other hand, if it is determined at A31 that the disconnection request is from a slave client, the client connection status (Connect) field of the user database 30 corresponding to the slave client is set to “0” at A34. After the connection of the slave client to the master client has been given a status of “disconnected” at A34, the slave client and the master client to which it was connected are notified of the new status settings at A35. To identify the master client, the system needs only to refer to the user database 30 and find the client having the same affiliated group (Group) field as the client that originated the disconnection request, and that also has a “1” set in the master mode (Master) field.

Thus, the proxy server 4, in response to a disconnection request from a client, terminates remote operations (connected status) between a slave client and a master client.

FIG. 7 is a flow diagram of the processing that is executed by the proxy server 4 in response to a request from a client for Web page viewing using a Web browser at a client. The role of the proxy server 4 here is to obtain the desired Web pages. At A41, upon receipt of a Web page request from a client, the proxy server 4 transmits the request at A42 for the specified Web page to the WWW server 5 using the URL of the WWW server 5, which is included in the request.

When the Web page is received from the WWW server 5 at A43 in response to the web page request, it is determined whether the client requesting the Web page is a master client having remote operation status. To make this determination, the user database 30 is accessed using the machine identification information (MID) contained in the request from the client to determine at A44 whether a “1” has been set in the master mode (Master) field for that client.

If it is determined that the request is a Web page request from a master client, the received Web page is transmitted to the master client. At the same time, the Web page is also sent to the slave clients at A45 that are in remote operation mode in relation to the master client. The Web page is displayed at both clients to achieve remote operation. If the Web page request is from a client other than a master client, the Web page that has been obtained is transmitted at A46 only to the client that originated the request.

The slave clients being remotely operated may be identified by referring to the machine identification information (MID), the client connection status (Connect), and the affiliated group (Group) fields of the user database 30. In other words, the slave clients are clients that have a “1” in the client connection status (Connect) and whose affiliated group (Group) is the same as the affiliated group of the master client.

FIG. 8 is a flow diagram of processing that occurs at a master client performing remote control operations. First, a client transmits to the proxy server 4 at A51 a request for connection to other clients. The connection will be based on the connection status of the other clients. Afterwards, the requesting client waits at A52 for a response from the proxy server 4 or for operational input from the user. If the requesting client determines at A52 that information received from the proxy server 4 is a response to a connection request, the requesting client creates a screen display at A53 based on the content of that response.

If another client can become a slave client, then upon receipt of connection permission notification from the proxy server 4, remote operation is established with the other client as a slave client and with the requesting client as the master client. Client mode classification is repeated if, according to the proxy server 4, it is determined that other clients can become slave clients. If the proxy server 4 is notified at A54 that the responses from all the clients indicate that connection should not be permitted, the client that originated the connection request will be notified by the proxy server 4 of this outcome. As a result, in the case of being notified by all clients that connection is not permitted, that outcome will be displayed and the processing to enter remote operation mode will be cancelled.

The Web page request is transmitted at A56 to the proxy server 4. The Web page, which is received at A57 from the proxy server 4, is displayed at A58 on the Web browser.

On the other hand, if it is determined at A59 that the user request is a request for release from remote operation mode (i.e., a request to terminate the connection with the slave client), the disconnection request is transmitted at A60 to the proxy server 4. Processing of the disconnection between the master client and slave client is executed at the proxy server 4. The execution results are transmitted at A61 by the proxy server 4 to the master client as a response to the disconnection request and displayed at A62, terminating the remote operations between the master client and the slave client.

FIG. 9 is a flow diagram of slave client processing under remote operations. First, a connection request is sent to the proxy server 4 from a client that can become a master client and a connection request event is received at A71 by a client that can become a slave client. Upon receiving the connection request event, an authentication screen is displayed at this client at A72 for approval/non-approval of the connection request. If, in response to this connection request, the user of this client approves the request, connection permission is transmitted at A73 to the proxy server 4 as the response to the connection request. On the other hand, if, in response to the connection request, the user of this client denies the connection request, “connection not permitted” is transmitted at A80 to the proxy server 4 as the response to the connection request, and processing ends.

After transmitting the connection permission at A73, user operation of the Web browser of the approving client is set to the “disabled” state at A74, and at the same time, the Web browser is set to the status of “regular reception allowed.” Thus, the approving client is set as a slave client by the proxy server 4 and, as a slave client, this client can no longer perform user operations on the slave client's Web browser. If the slave client then receives a Web page at A75, the Web page is displayed at A76 on the Web browser of the slave client. The Web page is obtained by the proxy server 4 based on user operations at the master client. The display content of the Web browser at the slave client is thus changed through operation of the master client.

After the processing at A74, if a disconnection request by a master client is received at A77 by the proxy server 4, the disconnection request is displayed at A78 on the screen of the slave client and, at the same time, user operation of the Web browser of the slave client is released at A79 from the disabled status.

Thus, a client that can become a master client may issue a request for remote operation mode and, in response, remote control of another client is performed. Alternatively, a client that can become a slave client may issue a request for remote operation mode and, in response, the slave client is remotely controlled by a client that can become a master client. Also, in remote operation mode, the connection between the master client and the slave client may be released by a disconnection request from the master client. Alternatively, a disconnection request may be sent to the proxy server 4 through the slave client and, in response, the connection between the master client and the slave client is released.

FIGS. 11-13 show examples of the information exchanged between the master client, the slave client, the proxy server 4, and the WWW server 5. Communication protocols between the clients and the servers may include TCP/IP, HTTP, etc. In FIGS. 11-13, “IP” refers to IP address, “Port” indicates the port number that is used for access, “TYPE” indicates whether the information is a request or a response, and “URL” refers to a Web page address. “MID” is the machine identification information. “ID” is the individual identification information of the user using the client. Also, “MS-ID” refers to the machine identification information for the master client 2, while “SV-ID” refers to the machine identification information for the slave client 3.

FIGS. 11A-11D illustrate examples of the types of information that are exchanged when remote operation mode is established between a master client and a slave client. FIG. 11A shows the information that is included in a connection request sent to the proxy server 4 from the Master client 2. In FIG. 11A, the IP address of the proxy server 4 is designated as “202.248.7.1” and the port number (Port) of the proxy server4 is specified as “1783.” The port number 1783 is used to send and receive data among all the clients. The TYPE “Master/Command” is specified to indicate that a request is being made for connection as a master client. The machine identification information (MID) of the client transmitting the connection request is “55682325789”, and the individual identification information (ID) of the user using of the requesting client is assigned “NAC55297”.

FIG. 11B shows the information contained in the corresponding response to the proxy server 4 from a client that can become a slave client that has received a connection request event. In FIG. 11B, the IP address of the proxy server 4 is “202.248.7.1” and the port number of the proxy server 4 is “1783”. The TYPE is specified as “Slave/Command,” which permits the client to become a slave client. The MS-ID, which is the individual identification information that indicates which user will become the slave client of the master client is specified as “NAC55297.” The slave client machine identification information (MID) and the individual identification information (ID) for the user of the slave client 3 is “GDE22345”.

The proxy server 4, receives a response from the slave client 3 in FIG. 11B and transmits responses to the master client 2 and the slave client 3, as shown in FIGS. 11C and 11D.

In FIG. 11C, the IP address of the master client 2 is “202.248.7.2”. The TYPE is specified as “Master/Response,” indicating that a connection request is permitted. In addition, the SV-ID, which is the user individual identification information for the user who is using the slave client 3, is “GDE22345” and indicates which client gave permission in response to the connection request.

In FIG. 11D, the IP address of the slave client 3 is “202.248.7.3”. The TYPE is “Slave/Response,” which indicates that remote operation status in relation to the Master Client 2 has been established. Also, the MS-ID, which is the individual identification information for the user of the master client 3, is “NAC55297,” indicating with which clients remote operation status has been established.

By exchanging the information shown in FIGS. 11A-11D, remote operation mode is established between the master client 2 and the slave client 3.

In response to a connection request from the proxy server 4, the user of the slave client 3 may deny the connection. If so, then in FIG. 11B, in the response to the connection request from the slave client 3, the TYPE would indicate “connection not permitted” (for example, SV-Cancel/Command may be specified).

Also, in FIG. 11C, if the connection request from the master client 2 for connection to the slave client 3 is denied, then the TYPE of response from the slave client 3 to the proxy server 4 may specify, for example, MS-Cancel/Response. In addition, in FIG. 11D, if a denial of the connection request is received, then TYPE may specify, for example, SV-Cancel/Response.

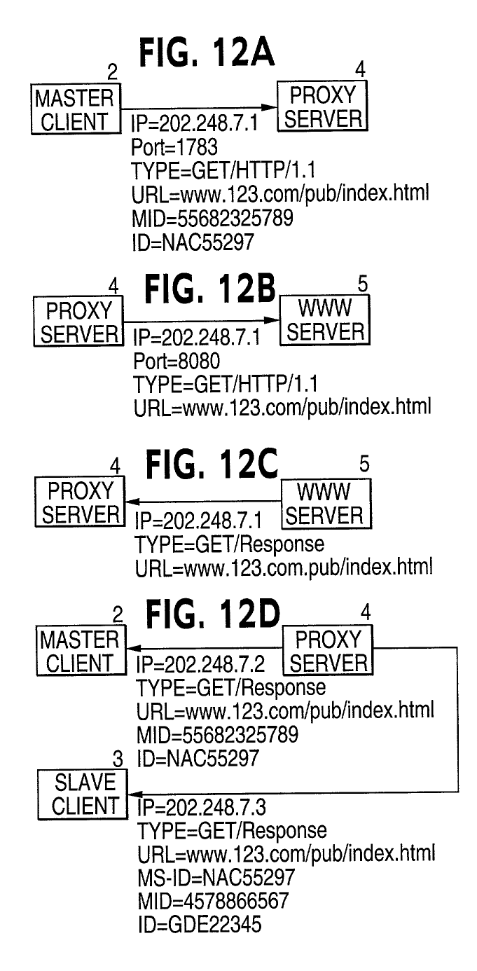

FIGS. 12A-12D illustrate examples of the information exchanged in Web page viewing processing when remote operating mode has been established. In the following description, explanations of types of information that are the same as in FIGS. 11A-11D are omitted.

FIG. 12A shows the information transmitted from the master client 2 to the proxy server 4 when the user of the master client 2 views a desired Web page using a Web browser. The IP address and the port number of the proxy server 4 are specified. In addition, “GET/HTTP/1.1” is specified for TYPE, where HTTP indicates that a Web page is requested, and the URL of the Web page is specified as “www.123.com/pub/index.html.”

FIG. 12B shows the information transmitted from the proxy server 4 to the WWW server 5 when transmission of a Web page specified by the master client 2 is requested of the WWW server 5. The IP address and a port number of “8080” are specified for the proxy server 4. The IP address indicates the originator of the Web page request and Port indicates the port number of the request originator. Also, the TYPE specifies a Web page request, and the URL of the Web page is provided.

As shown in FIG. 12C, the requested Web page is transmitted from the WWW server 5 to the proxy server 4. The IP address of the proxy server 4 is specified, the TYPE “GET/Response” indicates transmission of a requested Web page, and the URL of the Web page is specified.

FIG. 12D shows the information flow when the Web page obtained from the WWW server 5 is transmitted to the master client 2 and the slave client 3. The proxy server 4 transmits the Web page obtained from the WWW server 5 (for example, the page specified by the URL “www.123.com/pub/index.html”) to the master client 2, which is the originator of that request, specifying the IP address of the master client 2 and “GET/Response” as the TYPE.

The proxy server 4, in addition to transmitting the Web page to the master client 2, also sends the Web page to the slave client 3, specifying the IP address of the slave client 3 and “GET/Response” as the TYPE. The Web browsers of the master client 2 and the slave client 3 each display on their screens the Web page received from the proxy server 4.

FIG. 13A shows the information that is transmitted from the master client 2 to the proxy server 4 when the master client 2, which is in remote operation mode, issues a disconnection request. In FIG. 13A, the IP address of the proxy server 4 is specified, while the TYPE “Disconnect/Command” indicates the disconnection request. FIG. 13B shows the information that is transmitted from the proxy server 4 to the slave client 3 when the master client 2 receives a disconnection request. In FIG. 13B, the IP address of the slave client is specified, while the TYPE “Disconnect/Command” indicates the disconnection request. Through the process shown in FIGS. 13A and 13B, remote operation between the master client 2 and the slave client 3 is terminated. Moreover, while not shown in the figures, the content of the response from the slave client 3 is communicated from the proxy server 4 to the master client 2.

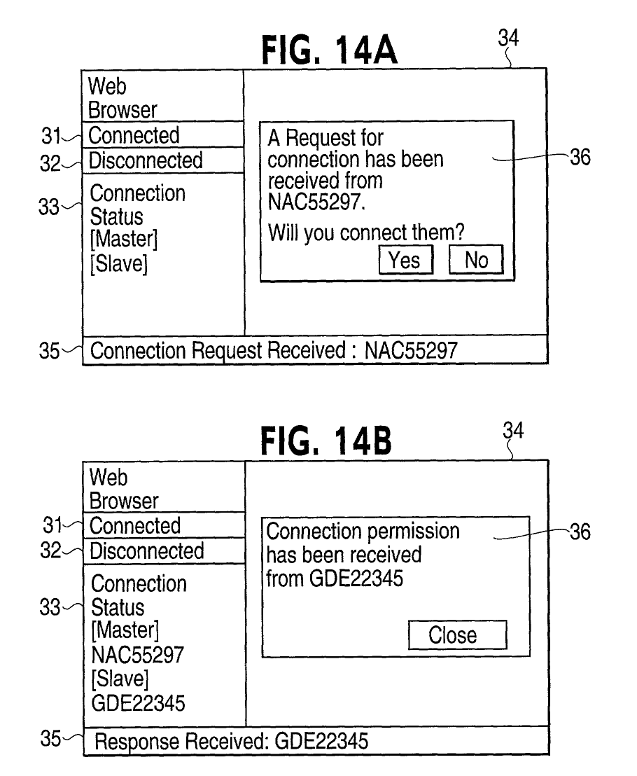

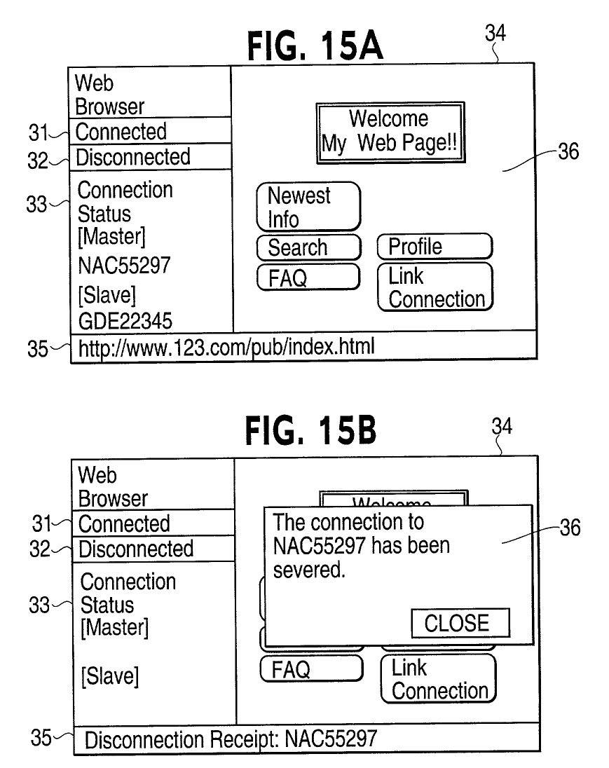

FIGS. 14A, 14B, 15A, and 15B show examples of client screen displays. More specifically, the figures show examples of client Web browser displays. The Web browser shown in FIGS. 14A, 14B, 15A, and 15B mainly comprises a connection button 31, a disconnection button 32, a connection status display part 33, a content display part 34, and a status information display part 35. Display objects, such as menu objects, etc., that are displayed on general Web browsers have been omitted.

In FIGS. 14A, 14B, 15A, and 15B, the connection button 31 is used to transmit a connection request from a client to the proxy server 4 when transitioning to remote operation mode. The disconnection button 32 is used to transmit a disconnection request from a client to the proxy server 4 when terminating remote operation mode.

The connection status display part 33 is the area of the screen that shows the remote operation status of the clients. In this area, the user individual identification information for the client that has become the master client 2 and the user individual identification information for the client that has become the slave client 3 are displayed. The content display part 34 is a screen area for displaying the Web pages that have been received, a message box for presenting received information to the user, etc. The status information display part 35 is a screen area for displaying the processing status of the Web browser, information related to the content displayed in the content display part 34, etc.

FIG. 14A shows an example of the screen display when a client uses the connection button 31 to send the proxy server 4 a connection request, or when the client has received such a connection request from the proxy server 4. In this display, the individual identification information showing the user of the client that originated the connection request, a message to the effect that such a connection request was received, and buttons for indicating whether the connection request is granted are displayed in a message box 36. By selecting the desired button in the message box, the information corresponding to the selected button is transmitted to the proxy server 4 as the response to the connection request.

FIG. 14B shows an example of the screen display when a response from a client regarding a connection request is received from the proxy server 4. In this display, the individual identification information showing the user of the client that responded to the connection request and a message showing the content of the response are displayed in the message box 36. In addition, if the response permits connection, the following information is displayed in the connection status display part 33: (1) the individual identification information showing the user of the client that originated the connection request, which is displayed as the master client, and (2) the individual identification information showing the user of the client that provided the response, which is displayed as the slave client.

In FIG. 14B, the message box 36 displays information indicating that connection permission was received from the client as a response to the connection request. In addition, the individual identification information “NAC55297” of the master client, the individual identification information “GDE22345” of the slave client, and information indicating these clients have transitioned to remote operation mode are also displayed.

FIG. 15A shows an example of the screen display of a client that has transitioned to remote operation mode. This figure displays a Web page in the contents display part 34 with the URL “http://www.123.com/pub/index.html”. The Web browser display is the same for both the master client 2 and the slave client 3.

FIG. 15B shows an example of the screen display of a client when disconnection from remote operation has been directed. In FIG. 15B, for example, the disconnection button 32 of the master client 2 has been pushed and a disconnection request has been sent from the master client 2 to the proxy server 4. FIG. 15B shows the screen display of the slave client 3 that has received the disconnection request from the proxy server 4.

In FIG. 15B, information is displayed in the message box 36 in the contents display part 34 of the slave client 3, indicating that the master client 2, whose user has individual identification information “NAC55297,” has transmitted a disconnection request. In addition, the individual identification information for the user of the master client 2 and the individual identification information for the user of the slave client 3, which was displayed in the connection status display part 33, are deleted and a message is displayed indicating that remote operation for these clients has been terminated and that these clients have transitioned to normal status.

In the present invention, the proxy server 4 performs the functions of receiving a request from either the master client or the slave client, processing the request, and sending the processing results to both the master and slave clients. The proxy server 4 has been described above as being independent of the clients. However, the program for executing the processing of the proxy server 4 and the program for executing the processing of the indicated client may be run on one apparatus. In that case, information is exchanged within that apparatus between the client program and the proxy server program, while information exchange with other clients is done using a network. The apparatus that runs both the client program and the proxy server program may be either the type that can become a master client or the type that can become a slave client.

The present invention may be applied, for example to a correspondence education (i.e., distance learning) service that uses a network. In that case, information on the computer of the lecturer (as he/she operates that computer) is displayed on the computer of each student participating in the lecture. As a result, the lecturer, without having to be concerned about the information that is displayed on the students' computers, may conduct the lecture more easily.

Another example application of the present invention is to invalid care services, where the care provider remotely operates a computer in the home of the care recipient. With the present invention, the care provider can provide information requested by the care recipient without going to the home of the care recipient.

Thus, according to the present invention, operations performed on one apparatus may be automatically performed on other apparatuses, as well. As a result, it is possible for one apparatus to remotely operate other apparatuses.

Also, remote operation may be achieved without the need for sending processing results through the controlling apparatus or for communication from the remotely operated apparatus back to the controlling apparatus. This reduces the processing load on each apparatus, as well as the amount of network traffic.

In addition, in the remote operation mode, because user operation has been disabled at the remote apparatuses, reliable remote operation may be achieved, thus, eliminating the possibility that operations may be performed on the remote apparatus that are different from those performed on the controlling apparatus.

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed:

1. A remote operation method, comprising:
sending a request from a first device to a management device to remotely operate a second device;
disabling, by the management device, user operation of the second device and establishing a remote operation relationship between the first device as a master device and the second device as a slave device;
sending another request from the first device to the management device to obtain a Web page;
obtaining the Web page by the management device from a Web server and sending the Web page to the first device and to the second device; and
displaying the Web page on a display of the first device and the second device.

2. A remote operation system, comprising:
a management device;
a first device connected to the management device via a network; and
a second device connected to the management device via a network,
wherein the first device sends a request to the management device to remotely operate the second device, the management device disables user operation of the second device and establishes a remote operation relationship between the first device as a master device and the second device as a slave device, the first device sends another request to the management device to obtain a Web page, the management device obtains the Web page from a Web server and sends the Web page obtained to the first device and to the second device, and the first device and the second device each display the Web page on a display.

3. A processing apparatus, comprising
a signal receiving unit receiving a request from a first control unit;
an execution unit executing processing in response to the request and generating processing results; and
a remote operation control unit simultaneously transmitting the processing results to the first control unit and to a second control unit different from the first control unit.

4. The processing apparatus of claim 3, wherein the request is a request to remotely operate the second control unit.

5. The processing apparatus of claim 3, wherein the second control unit comprises a plurality of control units.

6. The processing apparatus of claim 3, wherein the request is a request to obtain a Web page, the execution unit obtains the Web page, and the remote operation control unit simultaneously transmits the Web page obtained by the execution unit to the first control unit and to the second control unit.

7. A management apparatus, comprising:
a signal receiving unit receiving a request from a first apparatus;
can execution unit executing processing in response to the request and generating processing results; and
a remote operation control unit simultaneously transmitting the processing results to first apparatus and to a second apparatus different from the first apparatus.

8. The management apparatus of claim 7, wherein the second apparatus is a plurality of apparatuses connected to the first apparatus via a network.

9. The management apparatus of claim 7, wherein the request is a request to obtain a Web page, the execution unit obtains the Web page, and the remote operation control unit simultaneously transmits the Web page obtained by the execution unit to the first apparatus and to the second apparatus.

10. A computer system, comprising:
a first apparatus;
a management apparatus receiving processing requests from the first apparatus, executing processing in response to the processing requests, and generating processing results; and
a second apparatus remotely operated by the first apparatus, wherein the management apparatus simultaneously transmits the processing results to the first apparatus and to the second apparatus, and the second apparatus executing processing in response to the processing results.

11. The computer system of claim 10, wherein user operation of the second apparatus is disabled when the second apparatus is being remotely operated.

12. The computer system of claim 10, wherein each processing request is a request to obtain a Web page, and the first apparatus and the second apparatus receive, from the management apparatus, the Web page obtained in response to the processing request and display the Web page on a display screen of the first apparatus and the second apparatus.

13. A remote operation method, comprising:
receiving a processing request from a first control unit, executing processing in response to the request and generating processing results, and simultaneously transmitting the processing results to the first control unit and to a second control unit that is different from the first control unit.

14. The remote operation method of claim 13, wherein the second control unit is a plurality of control units.

15. The remote operation method of claim 13, wherein the processing request is a request to obtain a Web page, and the Web page obtained is simultaneously transmitted to the first control unit and to the second control unit.

16. A remote operation method comprising:
receiving a processing request from a first apparatus connected to a second apparatus by a network;
executing processing in response to the processing request and generating processing results; and
simultaneously transmitting the processing results to the first apparatus and to the second apparatus.

17. A computer-readable storage controlling a computer and comprising a process of:
receiving a request from a first control unit, executing processing in response to the request and generating processing results, and simultaneously transmitting the processing results to the first control unit and to a second unit that is different from the first control unit.

18. A computer-readable storage controlling a computer and comprising a process of:
receiving a request from a first apparatus, executing processing in response to the request and generating processing results, and simultaneously transmitting the processing results to the first apparatus and to a second apparatus that is different from the first apparatus.
